(19) United States
(12) Patent Application Publication
(10) Pub. No.: US 2010/0268816 A1
(43) Pub. Date: Oct. 21, 2010

(54) PERFORMANCE MONITORING SYSTEM, BOTTLENECK DETECTION METHOD AND MANAGEMENT SERVER FOR VIRTUAL MACHINE SYSTEM

(75) Inventors: Toshiaki TARUI, Sagamihara (JP); Tsuyoshi TANAKA, Kokubunji (JP); Kazuhiko MIZUNO, Hachioji (JP); Ken NAONO, Tokyo (JP)

Correspondence Address: MATTINGLY & MALUR, P.C., 1800 DIAGONAL ROAD, SUITE 370, ALEXANDRIA, VA, 22314, US

(73) Assignee: HITACHI, LTD., Tokyo (JP)

(21) Appl. No.: 12/758,105

(22) Filed: Apr. 12, 2010

(30) Foreign Application Priority Data
Apr. 17, 2009 (JP) 2009-101129

(51) Int. Cl. G06F 15/173; G06F 9/455

(52) U.S. Cl. 709/224; 718/1; 709/226

(57) ABSTRACT

A performance monitoring system, comprising: a server; a storage system; and a management server, the management server the management server is configured to: obtain the gathered time-sequential data from the server; judge whether at least one bottleneck has occurred in the logical resource of a specified one of the plurality of virtual machines at each time of the obtained time-sequential data, judge whether at least one bottleneck causing large influence on the specified one of the plurality of virtual machines has occurred; and notify that at least one large bottleneck has occurred in the specified one of the plurality of virtual machines.

### CLAIM OF PRIORITY

The present application claims priority from Japanese patent application JP 2009-101129 filed on Apr. 17, 2009, the content of which is hereby incorporated by reference into this application.

### BACKGROUND OF THE INVENTION

This invention relates to a virtual machine system, and a tool for assisting detection of a performance bottleneck factor among a plurality of virtual servers.

In recent years, higher performance of a CPU has been accompanied by widespread use of server virtualization where a plurality of systems shares one machine in order to realize cost reduction and operation flexibility by server integration.

In a system for implementing virtualization, a plurality of virtual servers is generated in one server, and each independent OS is operated. Hereinafter, a virtual server is referred to as a logical partition (LPAR).

Each LPAR uses one physical server in division (time-division or division on a CPU core basis), which can be seen as if a plurality of servers is independently present from a user.

As described above, in the virtualization system, a plurality of LPARs shares a single physical resource (CPU or I/O device). In a large system, an I/O device is shared by a storage area network (SAN) or the like, and hence a single physical resource (SAN switch or storage) is shared by a plurality of LPARs.

As described above, in the system for realizing virtualization, mapping is performed between a physical resource and a logical resource (set of LPARs and I/O device or CPU used by the LPARs) utilized by a user, thereby eliminating one-to-one correspondence. As a result, correspondence between a logical resource and a physical resource becomes complex, and hence it is difficult to judge which physical resource an application uses.

There are various tools for monitoring performance of each physical resource and each logical resource. However, in the virtualization system described above, which portion of a great volume of monitored data should be checked is difficult to judge.

For the above-mentioned reasons, conventional performance evaluation or a bottleneck detection method is difficult to be directly used.

In order to solve the problems, concerning performance monitoring at a plurality of servers, in a system where the plurality of servers shares a storage network, there is a method in which a management program is used for displaying an amount of a physical resource each server uses referring to a system structure table indicating physical-logical resource mapping based on performance data monitored in each server (for example, JP 2005-62941 A).

The use of the method described in JP 2005-62941 A enables judgment of which virtual server occupies which physical resource in an environment where the plurality of virtual servers shares one physical resource.

However, in a case where the plurality of servers shares the physical resource, in best effort (one who uses it wins), an amount of a physical resource each server uses cannot be controlled, and hence there is a problem that performance management cannot be performed.

In order to deal with this problem, an allocation policy is set for resources to be shared, and a resource usage amount of each server is controlled. For the allocation policy, various methods are used such as specification of a resource allocation ratio or a maximum resource usage amount, and priority specification.

For example, when a physical resource usage amount is allocated to each server via the storage network, there is a method for periodically monitoring a storage resource use situation of a virtual machine which dynamically changes, re-examining a resource allocation bandwidth, recovering extra resources, and reallocating resources according to priority (for example, JP 2005-309644 A).

In the virtualization system, a specific virtual server such as Domain 0 of Xen performs I/O processing on behalf of other virtual servers. In a case where communication processing of a given virtual server increases, CPU processing of the specific virtual server simultaneously increases, complicating bottleneck detection of the system.

In order to deal with this problem, there is a method for calculating a resource usage amount by considering the influence of I/O processing on the specific virtual server (for example, JP 2008-217332 A).

Further, in a storage system, when a physical resource causes a bottleneck, there is a method for displaying, by monitoring a traffic amount of a physical port in a connection path of an access path, a path having an available resource, and navigating path switching (for example, JP 2004-72135 A).

### SUMMARY OF THE INVENTION

In the above-mentioned conventional examples, it is possible to understand a use situation indicating an amount of a physical resource such as an I/O device or a CPU each LPAR uses.

However, for the following reasons, if only the use situation of the physical resource is monitored in the conventional technology, it is difficult to clarify which portion of the system has a performance problem.

(1) Detection of LPAR which Causes a Bottleneck by Using an Allocation Bandwidth of a Logical Resource to a Limit is Difficult

In a case where the plurality of LPARs shares a physical resource, and the use amount of the physical resource is limited by an allocation policy, there is a possibility that even a physical resource unused 100% may cause a bottleneck.

For example, in a system including two LPARs, there may be room in resource usage amount allocated to the LPAR 2 while a resource usage amount allocated to the LPAR 1 has been used up 100%. In such a case, while the resource usage amount of the physical resource is not 100%, the used amount of a relevant resource cannot be increased any more in the LPAR 1, and hence the LPAR 1 causes a bottleneck. In other words, bottleneck detection is necessary in this case.

(2) Influence on Application Performance is Unclear

In a case where a plurality of logical resources causes a bottleneck as described above, which of the logical resources has large influence on application performance is unclear. As a result, priority cannot be judged on measures for a plurality of bottlenecks, and hence no measures can be quickly taken.

For example, even when a resource usage amount of a storage device is 100%, application waiting time greatly varies from one length of a queue to another, resulting in different adverse effects on performance. In such a case, measures to deal with an item having a long queue and a large adverse effect on application waiting time should take priority. In other words, the performance monitoring system must judge priority to navigate a system administrator.

For these reasons, while simple performance monitoring is possible in the conventional technology, it is difficult to detect a point of causing low application performance, thereby creating a problem of pointing out which portion to be dealt with. Especially, in the large system, there may be a great many (several tens to several hundreds) of logical resource bottlenecks detected in (1). Hence, if only automatic detection of (1) is performed, it is very difficult to detect a point of measures.

It is an object of this invention to provide a monitoring system for assisting bottleneck detection by considering an allocation policy for physical resources and influence on application performance.

A representative aspect of this invention is as follows. A performance monitoring system, comprising: a server; a storage system coupled to the server; and a management server for managing the server and the storage system, wherein: the server comprises a first processor, a first memory coupled to the first processor, and a first network interface coupled to the first processor; the storage system comprises, a controller, a storage device, and a disk interface for interconnecting the controller and the storage device; the controller comprises a second processor, and a second memory coupled to the second processor; the management server comprises a third processor, a third memory coupled to the third processor, and a storage device coupled to the third processor; the server comprises a plurality of virtual machines executed therein, the plurality of virtual machines being generated by logically dividing the server; the storage system provides logical storage units, generated by logically dividing the storage device, to the plurality of virtual machines; logical resources, which are logically divided physical resources in a path from one of the plurality of virtual machine to the logical storage units, is allocated to each of the plurality of virtual machines; the server gathers time-sequential data regarding use amounts of the physical resources used for the logical resources, which are monitored by each of the plurality of virtual machines, for each of the logical resources; and the management server is configured to: manage information regarding a resource allocation policy set for the logical resources; obtain the gathered time-sequential data from the server; judge whether at least one bottleneck has occurred in the logical resource of a specified one of the plurality of virtual machines at each time of the obtained time-sequential data, by referring to use amounts of the physical resources used for the logical resources of the specified one of the plurality of virtual machines and the resource allocation policy; obtain a performance value indicating influence of performance of the logical resource where at least one bottleneck has occurred on performance of the specified one of the plurality of virtual machines; judge, based on the obtained performance value, whether at least one bottleneck causing large influence on the specified one of the plurality of virtual machines has occurred; and notify that at least one large bottleneck has occurred in the specified one of the plurality of virtual machines in a case where it is judged that at least one bottleneck causing large influence on the specified one of the plurality of virtual machines has occurred.

According to the embodiment of this invention, when presence of the bottleneck in the physical resource used by each virtual machine is judged, even in a state where the physical resource usage amount has not reached 100%, the virtual machine which causes the bottleneck can be detected.

Further, when there is a plurality of points judged to causes a bottleneck, a portion of each bottleneck portion having large influence on the virtual machine can be detected.

### BRIEF DESCRIPTION OF THE DRAWINGS

The present invention can be appreciated by the description which follows in conjunction with the following figures, wherein:

FIG. 1 is a block diagram illustrating a configuration of a monitoring system according to a first embodiment of this invention;

FIG. 2 is a block diagram illustrating a physical path on a storage access according to the first embodiment of this invention;

FIG. 3 is an explanatory diagram illustrating a logical configuration of coupling of each LPAR to a logical volume in a storage system according to the first embodiment of this invention;

FIG. 4 is an explanatory diagram illustrating in detail network communication processing performed via a management LPAR according to the first embodiment of this invention;

FIG. 5 is an explanatory diagram illustrating an example of a system structure table provided in a management server according to the first embodiment of this invention;

FIG. 6 is a diagram illustrating an example of a resource allocation policy provided in the management server according to the first embodiment of this invention;

FIG. 7 is a diagram illustrating a bottleneck portion reporting screen according to the first embodiment of this invention;

FIG. 8 is a diagram illustrating a physical resource bottleneck screen according to the first embodiment of this invention;

FIG. 9 is a flowchart illustrating processing of gathering use situations of all physical resources by the management server according to the first embodiment of this invention;

FIG. 10 is a flowchart illustrating bottleneck portion detection processing based on a resource allocation policy, which is executed by the management server according to the first embodiment of this invention;

FIG. 11 is a flowchart illustrating priority judgment processing of bottleneck measures considering resource waiting time executed by the management server according to the first embodiment of this invention;

FIG. 12 is a flowchart illustrating bottleneck solution processing executed by the management server according to the first embodiment of this invention;

FIG. 13A and FIG. 13B are an explanatory diagram illustrating an example of a resource allocation policy according to the first embodiment of this invention;

FIG. 14 is an explanatory diagram illustrating time-sequential performance data according to the first embodiment of this invention;

FIG. 15 is a flowchart illustrating a modified example of a display method of the physical resource bottleneck screen according to the first embodiment of this invention; and

FIG. 16 illustrates a calculation method of a resource waiting time ratio in a modified example of the first embodiment of this invention.

### DETAILED DESCRIPTION OF THE PREFERRED EMBODIMENTS

### First Embodiment

Hereinafter, referring to the accompanying drawings, an embodiment of this invention is described.

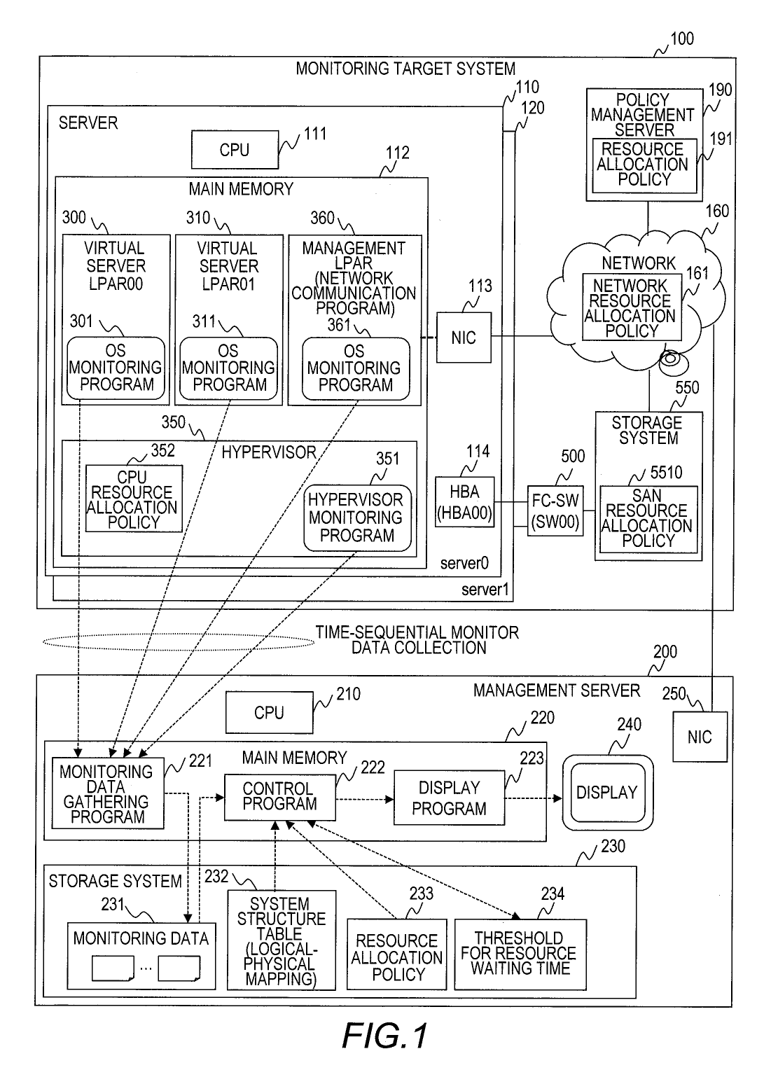

FIG. 1 is a block diagram illustrating a configuration of a monitoring system according to a first embodiment of this invention.

The monitoring system includes a monitoring target system 100 which is to be monitored and a management server 200.

The monitoring target system 100 includes a plurality of servers 110 and 120, a fiber channel switch (FC-SW) 500, a storage system 550, a network 160, and a policy management server 190.

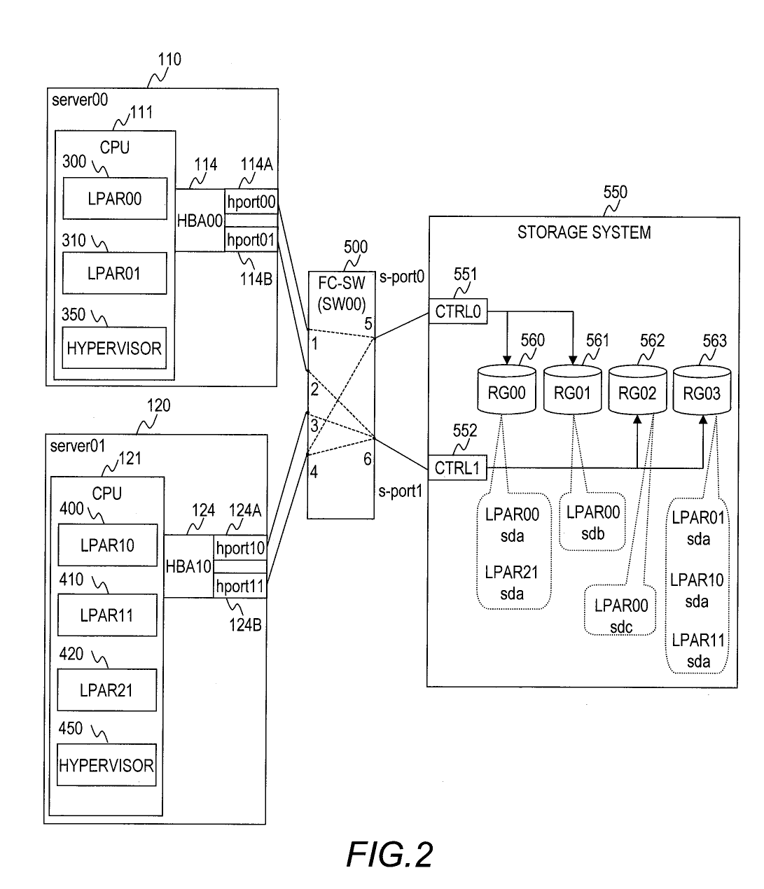

The server 110 is coupled to the policy management server 190 and the management server 200 via the network 160. The server 110 is coupled to the storage system 550 via a storage area network (SAN). Specifically, the servers 110 and 120 and the storage system 550 are coupled to each other via a storage interface (host bus adapter: HBA) 114, the FC-SW 500, and controllers 551 and 552 (refer to FIG. 2).

Hereinafter, the server 110 is described in detail. The server 120 is similar in configuration to server 110. In the drawing, a solid line indicates a network coupling relationship, and a dotted line indicates a flow of data.

The server 110 includes a CPU 111, a main memory 112, a network interface (network interface card: NIC) 113, and the HBA 114.

The server 110 has a virtualization mechanism. By the virtualization mechanism, the server 110 is logically divided into a plurality of LPARs, and each LPAR functions as a virtual server.

The main memory 112 of the server 110 stores a hypervisor 350 which is a control program for realizing virtualization, and an LPAR 300, an LPAR 310, and a management LPAR 360 which are programs for LPARs (including management LPAR). The programs are executed by the CPU 111.

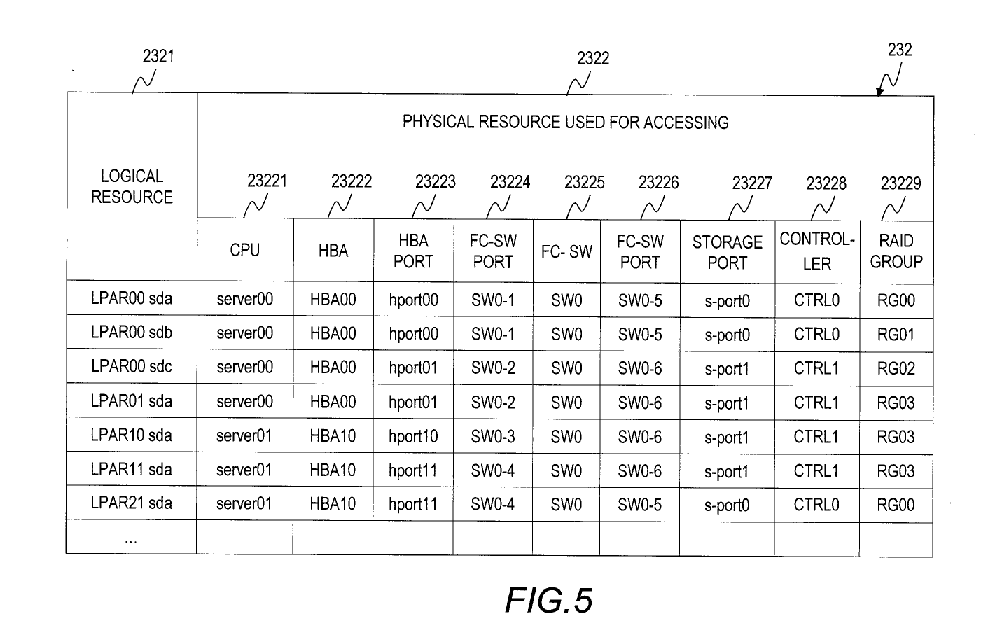

The LPARs 300 and 310 are virtual servers for executing user programs. The management LPAR 360 has a communication function for the LPARs 300 and 310 via the network 160, realizing virtualization of network I/O. Specifically, the management LPAR 360 supports realization of a virtual NIC which the LPARs 300 and 310 use for communication, realization of a virtual switch for coupling the LPARs 300 and 310 and the NIC 113, and realization of I/O to the network 160 via the NIC 113. Referring to FIG. 4, this arrangement is described in detail below.

The CPU 111 executes the LPARs 300 and 310 via the hypervisor 350. Accordingly, an OS and a virtual server including an application are provided to the user.

In the LPARs 300, 310, and 360, on OSs operated in the LPARs 300, 310 and 360, OS monitoring programs 301, 311 and 361 are executed, and basic information on the OS and I/O is periodically monitored.

In the hypervisor 350, a hypervisor monitoring program 351 is executed, and basic performance information such as CPU time allocated to each of the LPARs 300, 310 and 360 is monitored.

As examples of OS monitoring programs, there are sar and iostat of UNIX (registered trademark)-based OS, and system monitor of Windows (registered trademark)-based OS. As an example of a hypervisor monitoring function, there is xenotop of Xen (registered trademark).

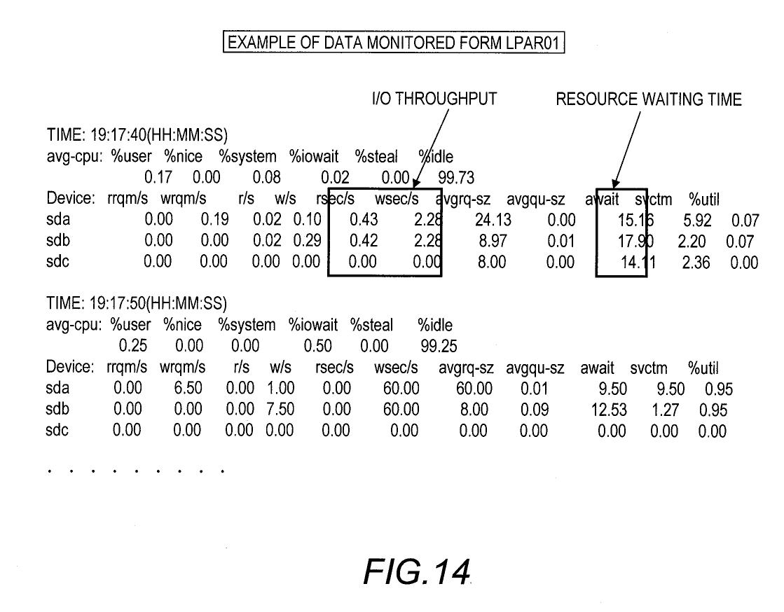

The monitored data are gathered, based on a monitoring data gathering program 221 described below, in a storage system 230 of the management server 200 via the network 160. Information to be monitored is described below referring to FIG. 14.

As performance data, for example, there are storage access throughput (throughput of accessing a logical device generated in the storage system 550 by the OS of each of the LPARs 300, 310 and 360), average waiting time of storage (average waiting time of storage access for each logical device monitored on the OS), and a use rate of the CPU 111 of each of the LPARs 300, 310 and 360 in the server 110.

The policy management server 190 manages allocation of physical resources (CPU, storage 150, network 160, and the like of each of the servers 110 and 120) used by the LPARs 300, 310, and 360 operated in the monitoring target system 100. Specifically, the policy management server 190 manages allocation of physical resources to the LPARs 300, 310 and 360 based on a resource allocation policy 191. The resource allocation policy 191 is set and managed by the policy management server 190.

Based on the resource allocation policy 191, for the CPU 111 of the server 110, a CPU resource allocation policy 352 is set in the hypervisor 350, a SAN resource allocation policy 5510 is set for the storage system 550, and a network resource allocation policy 161 is set for a device (not shown) in the network 160.

In the first embodiment, policy management targets are CPU allocation time, a network band, and a SAN band in the storage system 550.

The management server 200 is a machine where a monitoring function operates, and includes a CPU 210, a main memory 220, a storage system 230, a display device 240, and a NIC 250.

The management server 200 is coupled to the network 160 of the monitoring target system 100 via the NIC 250.

The main memory 220 stores a control program 222, a monitoring data gathering program 221, and a display program 223. Each program is executed by the CPU 210, thereby realizing a monitoring function.

The storage system 230 stores monitoring data 231 monitored by the monitoring target system 100 and gathered based on the monitoring data gathering program 221, and management data used by the control program 222. Specifically, the storage system 230 stores, as management data, a system structure table 232, a resource allocation policy 233, and a threshold for resource waiting time 234.

The system structure table 232 stores mapping of logical resources and physical resources at each LPAR. The resource allocation policy 233 is identical to the resource allocation policy 191 stored in the policy management server 190. The threshold for resource waiting time 234 is input by a system administrator. For example, the system administrator inputs the threshold for resource waiting time 234 by using the display device.

The management server 200 executes the monitoring data gathering program 221, and stores time-sequential data of performance monitored by the monitoring programs (OS monitoring programs 301, 311 361, and hypervisor monitoring program 351) in the monitoring target system 100 as monitoring data 231 in the storage system 230 via the network 160.

In the management server 200, processing described below is executed by executing the control program 222, and a result of the processing is displayed on the display device 240 by executing the display program 223. The display program 223 also executes parameter input processing from the display device 240.

In the example of FIG. 1, the monitoring target system 100 includes the two servers 110 and 120. However, the monitoring target system 100 may include one, or three or more servers. In the example of FIG. 1, there are two normal (user program executing) LPARs. However, one, or three or more LPARs may be provided.

FIG. 2 is a block diagram illustrating a physical path on the storage access according to the first embodiment of this invention.

FIG. 2 illustrates only the CPUs 111 and 121, the LPARs 300, 310, 400, 410, and 420 operated on the CPUs 111 and 121, the hypervisors 350 and 450, and the HBAs 114 and 124 in the servers 110 and 120, while not illustrating the other components.

The storage system 550 includes controllers 551 and 552, and a plurality of storage media (not shown), and generates a plurality of RAID Groups from the plurality of storage media. In the example of FIG. 2, RAID Groups 560 to 563 are generated in the storage system 550.

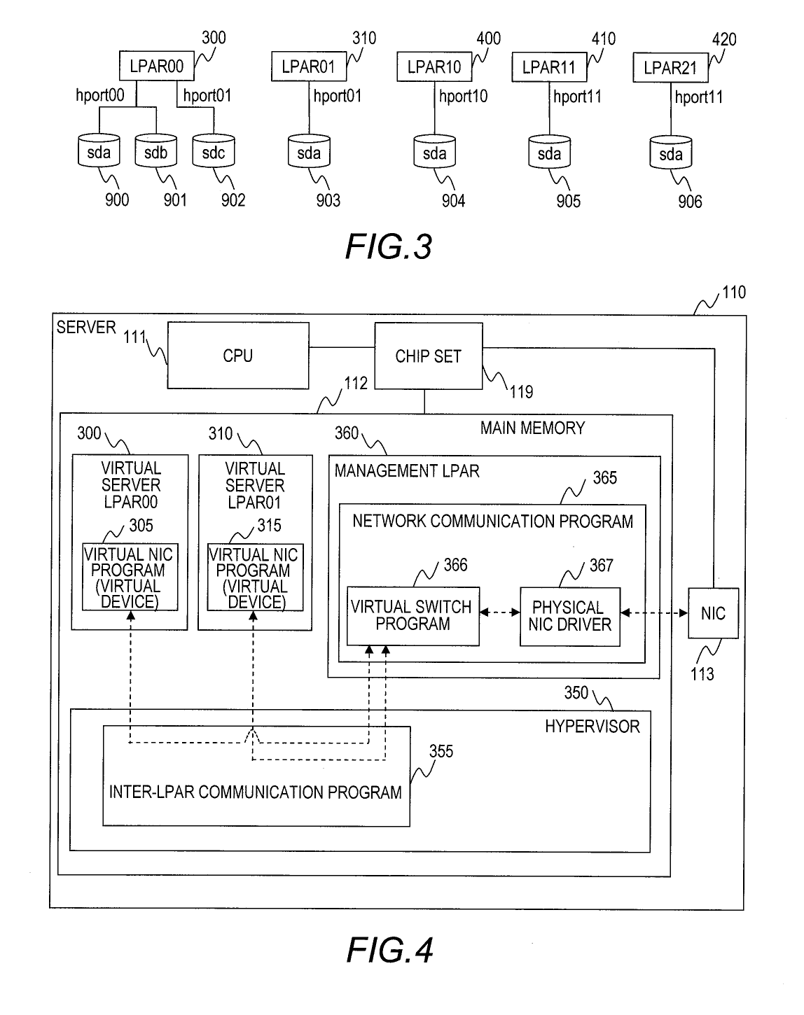

The storage system 550 further generates logical volumes (refer to FIG. 3) in the RAID Groups 560 to 563.

The servers 110 and 120 are coupled to the storage system 550 via the HBAs 114 and 124, respectively.

In the example of FIG. 2, the controllers 551 and 552 each include a port, and are coupled to the FC-SW 500 via the port. Specifically, RAID Groups RG00 and RG01 are accessed via a CTRL0 controller, and RAID Groups 02 and 03 are accessed via a CTRL1 controller.

The logical volumes are arranged so as to be dispersed to the RAID Groups. In the example of FIG. 2, in the RG00 (560), a logical volume sda is generated to be accessed by the LPAR00 (300) and a logical volume sda is generated to be accessed by the LPAR21 (420), respectively. In the RG01 (561), a logical volume sdb is generated to be accessed by the LPAR00 (300). In the RG02 (562), a logical volume sdc is generated to be accessed by the LPAR00 (300). In the RG03 (563), a logical volume sda is generated to be accessed by the LPAR01 (310), a logical volume sda is generated to be accessed by the LPAR10 (400), and a logical volume sda is generated to be accessed by the LPAR11 (410), respectively.

FIG. 3 is an explanatory diagram illustrating a logical configuration of coupling of each LPAR to the logical volume in the storage system 550 according to the first embodiment of this invention.

In FIG. 3, logical volumes 900 to 906 such as sda are allocated to each of the LPARs 300, 310, 400, 410, and 420, and logically configured as illustrated in FIG. 3.

The LPARs 300, 310, 400, 410 and 420 access the logical volumes 900 to 906 via two ports. To describe in detail by taking an example of the LPAR00 (300), the logical volumes sda 900 and sdb 901 are accessed via a port hport00 (114A) of the HBA 114, and the logical volume sdc 902 is accessed via a port hport01 (114B) of the HBA 114. In order to realize the above-mentioned configuration, a port 1 of the FC-SW 500 must be coupled to a port 5, and a port 2 of the FC-SW 500 must be coupled to a port 6, respectively.

For the other LPARs 310, 350, 400, 410 and 420, in order to realize the configuration as illustrated in FIG. 3, the FC-SW 500 must be coupled as indicated by dotted lines of FIG. 2 in view of a storage access path.

FIG. 4 is an explanatory diagram illustrating in detail network communication processing performed via the management LPAR 360 according to the first embodiment of this invention.

Hereinafter, processing accompanying communication via the management LPAR 360 is described by taking an example of network communication.

The LPARs 300 and 310 include virtual NIC programs 305 and 315 for performing communication, respectively.

The virtual NIC programs 305 and 315 function as virtual devices for a program (OS) on the management LPAR 360, and the LPARs 300 and 310 operate as if the LPARs 300 and 310 include NICs. The virtual NIC programs 305 and 315 communicate with a network communication program 365 included in the management LPAR 360 via an inter-LPAR communication program 355 provided by the hypervisor 350.

The network communication program 365 includes a virtual switch program 366 and a physical NIC driver 367. The virtual switch program 366 performs communication switching between the LPARs 300 and 310 and between the LPARs 300 and 310 and a device outside the server 110. The physical NIC driver 367 performs communication via a physical NIC when the LPARs 300 and 310 communicate with the device outside the server 110.

As described above, the reason for the necessity of communication processing via the management LPAR 360 is that the NIC 113 includes no virtualization mechanism and cannot deal with communication from the plurality of LPARs 300 and 310. As a result, software processing in the management LPAR 360 enables sharing of one NIC by the plurality of LPARs 300 and 310. When the I/O adapter includes a hardware virtualization mechanism, each LPAR can directly access the I/O adapter. Thus, processing to be performed via the management LPAR 360 is not performed.

FIG. 5 is an explanatory diagram illustrating an example of the system structure table 232 provided in the management server 200 according to the first embodiment of this invention.

In this embodiment, the system structure table 232 stores, concerning access to the storage system 550 via the SAN, physical resources (horizontal axis) used for accessing the storage system 550 for each logical resource (vertical axis) of each LPAR. In other words, the system structure table 232 stores an access path.

The system structure table 232 includes a logical resource 2321 and a physical resource 2322 used for accessing.

The logical resource 2321 stores an identifier for identifying a logical volume accessed by each LPAR. The physical resource 2322 used for accessing stores physical resources used for accessing a logical volume in the storage system 550 from an LPAR corresponding to the logical resource 2321.

Specifically, the physical resource 2322 used for accessing includes a CPU 23221, a HBA 23222, a HBA port 23223, a FC-SW port 23224, a FC-SW 23225, a FC-SW port 23226, a storage port 23227, a controller 23228, and a RAID Group 23229.

The CPU 23221 stores an identifier for identifying a CPU which operates an LPAR. The HBA 23222 stores an identifier for identifying a HBA provided in the server. The HBA port 23223 stores an identifier for identifying a HBA port provided in the HBA.

The FC-SW port 23224 stores an identifier for identifying an input port provided in the FC-SW. The FC-SW 23225 stores an identifier for identifying a FC-SW. The FC-SW port 23226 stores an identifier for identifying an output port provided in the FC-SW.

The storage port 23227 stores an identifier for identifying a port provided in the storage system. The controller 23228 stores an identifier for identifying a controller provided in the storage system. The RAID Group 23229 stores an identifier for identifying a RAID Group generated in the storage system.

For example, concerning access from the LPAR00 (300) to the sda 900, via “server00” of the CPU 23221, “HBA00” of the HBA 23222, “hport00” of the HBA port 23223, “SW 0-1” of the FC-SW port 23224, “SW 0” of the FC-SW 23225, “SW 0-5” of the FC-SW port 23226, “s-port1” of the storage port 23227, and “CTRL0” of the controller 23228, data stored in the sda 900 of “RG00” of the RAID Group 23229 is eventually accessed.

For other logical resources (logical volumes), access paths are similarly stored.

The management server 200 includes the system structure table 232, and can thereby understand mapping between physical resources and logical resources. The system administrator inputs each content of the system structure table 232 based on system design information at the time of system establishment.

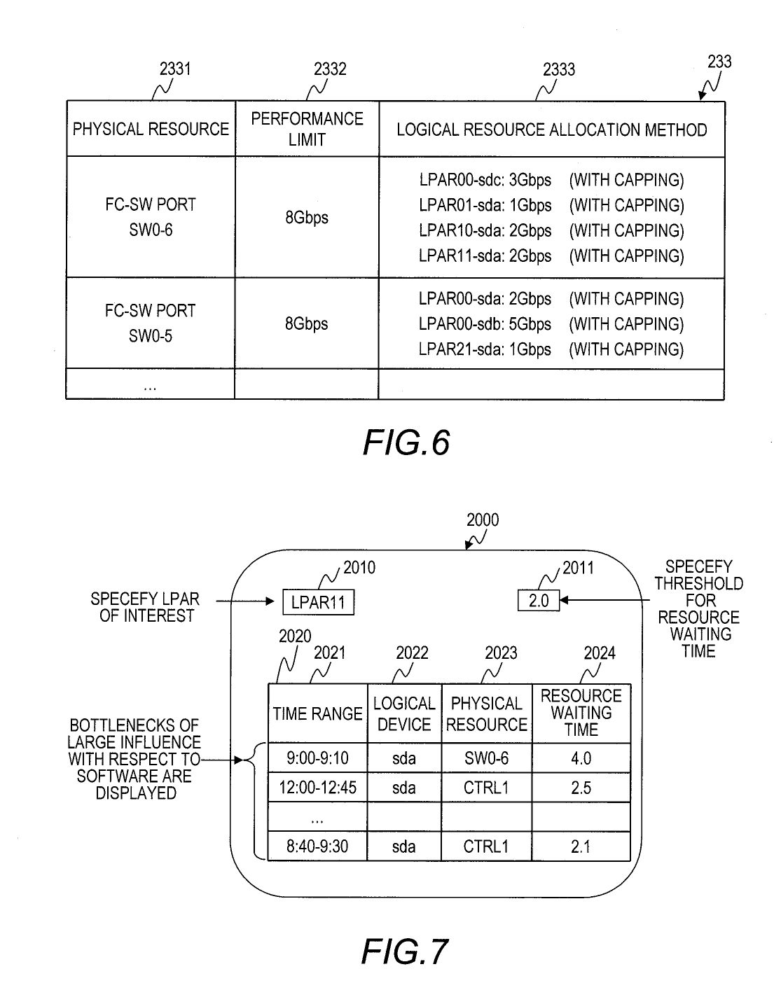

FIG. 6 is a diagram illustrating an example of the resource allocation policy 233 provided in the management server 200 according to the first embodiment of this invention.

The resource allocation policy 233 is generated from the resource allocation policy 191 managed by the policy management server 190. The resource allocation policy 191 is a parameter which the system administrator inputs at the time of system establishment or sizing.

The resource allocation policy 233 includes a physical resource 2331, performance limit 2332, and a logical resources allocation method 2333.

The physical resource 2331 stores an identifier for identifying a physical resource where a policy is set. The a performance limit 2332 stores a content of a policy set in a physical resource corresponding to the physical resource 2331. The logical resources allocation method 2333 stores a content of a policy set in logical resources which use the physical resource corresponding to the physical resource 2331.

The example of FIG. 6 illustrates only two entries. However, there may be entries regarding a plurality of other physical resources.

In this embodiment, based on a policy, an allocation value of a band usable by logical resources allocated to the LPAR is set.

In the example of FIG. 6, the physical resource 2331 is “port SW 0-6 of FC-SW 500”, and the performance limit 2332 of the port is “8 Gbps”. For access to four logical resources (logical volumes in this case) via the port, a band of “3 Gbps” is allocated to the sdc 902 of the LPAR00 (300), a band of “1 Gbps” is allocated to the sda 903 of the LPAR01 (310), a band of “2 Gbps” is allocated to the sda 904 of the LPAR10 (400), and a band of “2 Gbps” is allocated to the sda 905 of the LPAR11 (410).

In this embodiment, presence of capping is specified in band allocation to each logical resource.

“With capping” indicates that even if a band allocated for accessing another logical resource is available, this band cannot be used. “Without capping” indicates that when a band allocated for accessing another logical resource is available, the available band can be used.

In the example of FIG. 6, a band allocated to each logical resource is used as an allocation policy. However, various other factors such as allocation ratio specification, priority control, and minimum allocation ratio specification may be used. A case of control by a best effort placing no limit on used bands of logical resources may even be employed.

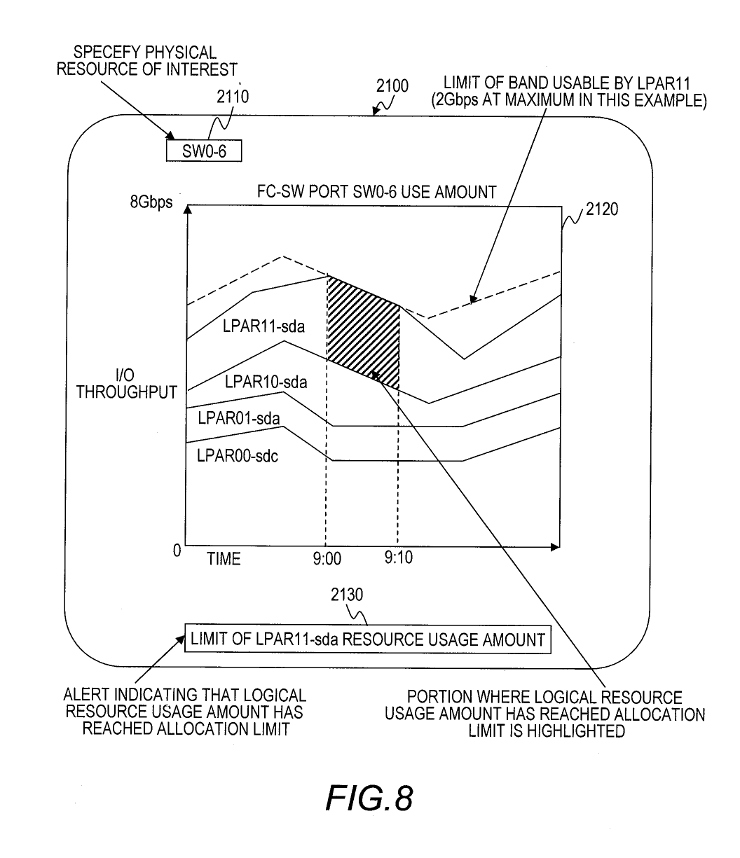

FIGS. 7 and 8 illustrate display screens of bottleneck detection results according to the first embodiment of this invention. The management server 200 judges, based on the monitoring data 231 obtained from the monitoring target system 100, presence of a bottleneck by executing the control program 222 according to an algorithm described below, and then executes the display program 223 to display the screens of FIGS. 7 and 8 on the display device 240.

FIG. 7 is a diagram illustrating a bottleneck portion reporting screen 2000 according to the first embodiment of this invention.

The bottleneck portion reporting screen 2000 is a screen for reporting bottlenecks of large influence on the LPAR.

The bottleneck portion reporting screen 2000 includes an input field 2010 for specifying an LPAR of interest, an input field 2011 for specifying a threshold 234 for resource waiting time, and an output table 2020 for reporting bottleneck portions.

The output table 2020 includes a time range 2021, a logical device 2022, a physical resource 2023, and resource waiting time 2024.

The time range 2021 indicates a time interval at which an LPAR of interest is judged to cause a bottleneck.

The logical device 2022 indicates a logical device (logical volume in this case) accessed by the LPAR of interest. The physical resource 2023 indicates a physical resource used to a limit in an access path from the LPAR of interest to the logical device, in other words, a physical resource which causes a bottleneck. The resource waiting time 2024 indicates an average value of resource waiting time.

The resource waiting time 2024 is a parameter indicating influence of logical resource access performance on server performance. As the value is larger, an adverse effect on software performance is larger.

The bottleneck portion reporting screen 2000 displays bottleneck portions in descending order of resource waiting time only for logical resources where actually monitored resource waiting time is larger than the threshold 234 for resource waiting time input to the input field 2011. In other words, bottleneck portions are displayed in descending order of influence with respect to software.

Thus, the system administrator can know bottleneck portions of large influence on application performance.

In the example of FIG. 7, among bottlenecks regarding the LPAR11 (410), bottlenecks where resource waiting time is “2.0” or longer are displayed. For example, a first item of the bottleneck portion reporting screen 2000 of FIG. 7 indicates that during a period of 9:00 to 9:10, for access to the logical volume sda 905, a band allocated to the port SW 0-6 of the FC-SW 500 is used to a limit, and the resource waiting time 2024 is “4.0”. For other rows, other bottleneck portions are displayed.

Resource waiting time is described in detail. In a case where an application is for access to a logical device, a queue is prepared for access by the OS. A band of any one of physical resources in the access path is subjected to rate-controlling to cause a shortage of access bands of logical resources. In a case where I/O requests accumulate, an access request queue is generated in the queue, and the requests are kept waiting.

The resource waiting time is indicated by a value obtained by monitoring I/O request waiting time in the OS described above. As a value of resource waiting time is larger, influence of an access band shortage on the application is larger.

For example, in the case of the UNIX (registered trademark)-based OS, I/O waiting time can be monitored by an item of await by an iostat command which is an OS standard command. In the case of other OSs, I/O waiting time can be monitored by similar basic commands.

For a parameter indicating influence of a bottleneck on I/O performance, not only the resource waiting time described above but also an average queue length can be used. In particular, in a case where a CPU causes a bottleneck, an average queue length can be monitored as a load average.

FIG. 8 is a diagram illustrating a physical resource bottleneck screen 2100 according to the first embodiment of this invention.

The physical resource bottleneck screen 2100 is a screen for reporting a portion which has reached a use limit of a resource allocated to a physical resource.

The physical resource bottleneck screen 2100 includes an input field 2110 for specifying a physical resource of interest, an output graph 2120 for displaying a resource usage amount, and an alert output field 2130 for displaying which logical resource causes a bottleneck.

In the output graph 2120, a vertical axis indicates I/O throughput, and a horizontal axis indicates time. In the output graph 2120, at each time, an amount of a physical resource used when each LPAR using the physical resource of interest (port SW 0-6 of the FC-SW 500 in the example of FIG. 8) accesses a logical device is displayed in the form of a cumulative area graph.

Further, the output graph 2120 highlights a (bottleneck) portion which has used up an allocated band in accessing to a logical device.

In the example of FIG. 8, in ascending order, time changes of I/O access throughput for the sdc 902 of the LPAR00 (300), the sda 903 of the LPAR01 (310), the sda 904 of the LPAR10 (400), and the sda 905 of the LPAR11 (410) are displayed.

In the example of FIG. 8, access to the sda 905 of the LPAR11 (410) is limited to 2 Gbps. In FIG. 8, a dotted line indicates an upper limit of a band usable by the sda 905 of the LPAR11 (410). As illustrated in FIG. 8, during a period of 9:00 to 9:10, for access to the sda 905 of the LPAR11 (410), the band of 2 Gbps has been used up. Hence, this portion is highlighted by a hatched line, and a message that a resource usage amount of the logical device has reached a band allocation limit is displayed in the alert output field 2130.

The upper limit of the band usable by the sda 905 of the LPAR11 (410) does not need to be indicated by a dotted line, but only the hatched portion may be displayed.

Thus, the system administrator can monitor which logical resource access has reached a band limit (whether a bottleneck has occurred) at what time, and a use amount of the physical resource for access to another logical resource at the time of the occurrence of the bottleneck.

As a display method for the bottleneck portion reporting screen 2000 and the physical resource bottleneck screen 2100, there may be employed a method in which the bottleneck portion reporting screen 2000 is displayed first, judges a portion causing a bottleneck and order of priority of measures, then the physical resource bottleneck screen 2100 is displayed, and the system administrator monitors a time-sequential change of a resource usage amount of a relevant physical resource (amount of the relevant physical resource that another LPAR uses in the bottleneck portion) and estimates a cause thereof. The display method for the bottleneck portion reporting screen 2000 and the physical resource bottleneck screen 2100 is not limited to this method. For example, these screens may be simultaneously displayed.

Next, processing of the management server 200 is described.

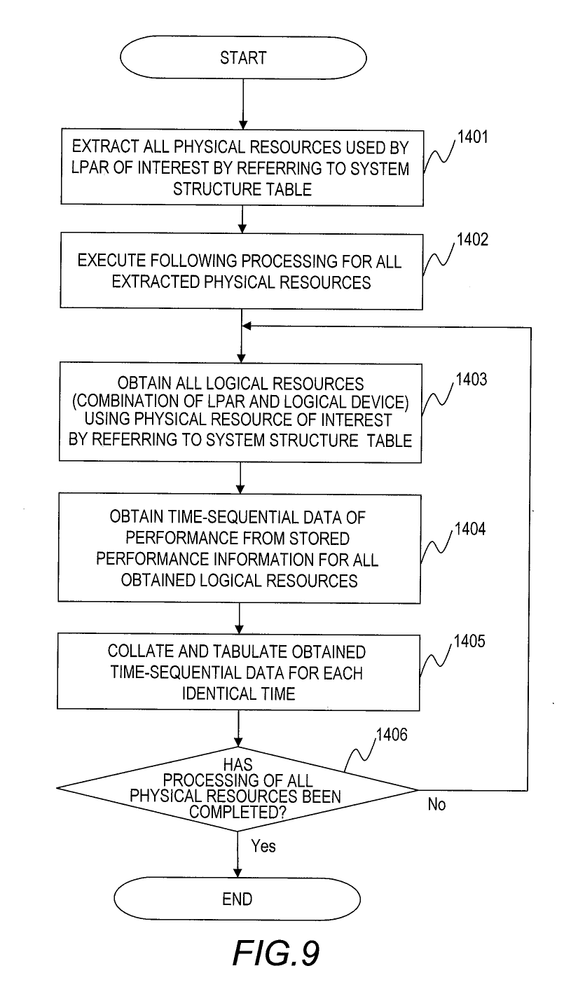

A feature of the first embodiment of this invention is that the management server 200 performs processing illustrated in FIGS. 9 to 12 by executing the control program 222.

<Processing of Management Server 200>

Hereinafter, referring to FIGS. 9 to 14, a monitoring system of this invention, in other words, an operation of the management server 200, is described.

The management server 200 executes the monitoring data gathering program 221 to gather performance data as illustrated in FIG. 14, and stores the gathered performance data as the monitoring data 231 in the storage system 230.

This processing can be realized by, for example, starting an iostat command in a remote shell. The management server 200 executes a bottleneck analysis based on the stored monitoring data 231.

FIG. 14 is an explanatory diagram illustrating time-sequential performance data according to the first embodiment of this invention.

The time-sequential performance data is monitored by the OS of each LPAR (300 or 310), which is to be stored as the monitoring data 231 of the management server 200. In the example of FIG. 14, data monitored at equal intervals (10-second intervals in this case) by iostat command of Linux (registered trademark) is stored. FIG. 14 illustrates data monitored at 19:17:40 (HH:MM:SS) and 19:17:50. Data is stored similarly thereafter. Hereinafter, contents of data monitored at each time are described sequentially.

Two rows next to time indicate details of a CPU (111) period monitored by the OS of the LPAR (300 or 310), and each item has the following meaning.

An item % user indicates a ratio of operation time in a user mode. An item % nice indicates a ratio of operation time in a user mode of low priority. An item % system indicates a ratio of operation time in a system mode. An item % iowait indicates a ratio of waiting time for I/O completion. An item % steal indicates a ratio of time consumed by another operating system in a virtualization environment. An item % idle indicates a ratio of task waiting time.

The next four rows of the monitored data indicate I/O operation situations monitored by the OS of each LPAR (300 or 310), and monitored for each I/O device. Each item has the following meaning.

An item Device indicates a logical device name on the OS. An item rrqm/s indicates the number of merged requests per second with respect to the device. An item wrpm/s indicates the number of merged requests per second with respect to the device. An item r/s indicates the number of reading requests per second with respect to the device. An item w/s indicates the number of writing requests per second with respect to the device. An item rsec/s indicates the number of sectors per second (throughput) read from the device. An item wsec/s indicates the number of sectors per second (throughput) written in the device. An item avgrq-sz indicates an average size (sector basis) of requests with respect to the device. An item avgqu-sz indicates an average length of request queues of the device. An item await indicates average waiting time until service termination of an I/O request to the device. An item svctm indicates average service time of I/O requests to the device. An item % util indicates an average use rate of the device.

In this embodiment, resource waiting time await is used as an index to indicate influence of I/O access performance on software. For contents of the time-sequential performance data stored as the monitoring data 231, in addition to the iostat of FIG. 14, various commands such as a sar command and a xentop command of the hypervisor can be output.

FIG. 9 is a flowchart illustrating processing of gathering use situations of all physical resources by the management server 200 according to the first embodiment of this invention.

This processing is for gathering a use situation of each physical resource which becomes necessary for executing bottleneck judgment.

This processing is started by specifying an LPAR of interest in the input field 2010 of the bottleneck portion reporting screen 2000 by the system administrator.

In Step 1401, the control program 222 extracts all physical resources used by an LPAR (hereinafter, also referred to as LPAR of interest) input to the input field 2010 by referring to the system structure table 232.

In the example of FIG. 7, the LPAR11 (410) is input to the input field 2010. As physical resources used by the LPAR11 (410), the control program 222 extracts “server01” of the CPU 23221, “HBA10” of the HBA 23222, “hport11” of the HBA port 23223, “SW 0-4” of the FC-SW port 23224, “SW 0” of the FC-SW 23225, “SW 0-6” of the FC-SW port 23226, “s-port1” of the storage port 23227, “CTRL1” of the controller 23228, and “RG03” of the RAID Group 23229.

In Step 1402, the control program 222 executes the following processing (Steps 1403 to 1405) for all the extracted physical resources. Specifically, the control program 222 selects one of all the extracted physical resources, and executes the processing of Steps 1403 to 1405 for the selected physical resource (hereinafter, also referred to as a physical resource of interest).

In Step 1403, the control program 222 obtains all logical resources (in this case, combinations of LPAR and logical device) which use the physical resource of interest by referring to the system structure table 232.

For example, in a case where the selected physical resource of interest is a port SW 0-6 of the FC-SW 500, the sdc 902 of the LPAR00 (300), the sda 903 of the LPAR01 (310), the sda 904 of the LPAR10 (400), and the sda 905 of the LPAR11 (410) are obtained as logical resources which use the physical resource of interest.

In Step 1404, the control program 222 obtains a time-sequential data of performance from the stored monitoring data 231 for all the obtained logical resources.

In Step 1405, the control program 222 collates and tabulates the obtained time-sequential data for each identical time in all the logical resources.

In Step 1406, the control program 222 judges whether processing for all the physical resources extracted in Step 1401 has been executed.

If it is judged that processing for all the physical resources extracted in Step 1401 has not been executed, the control program 222 returns to Step 1403, and selects one unprocessed physical resource to execute the same processing (Steps 1403 to 1406).

If it is judged that processing for all the physical resources extracted in Step 1401 has been executed, the control program 222 ends the processing.

Through this processing, an amount of a physical resource used for access of the LPAR of interest to each logical device at each time can be known.

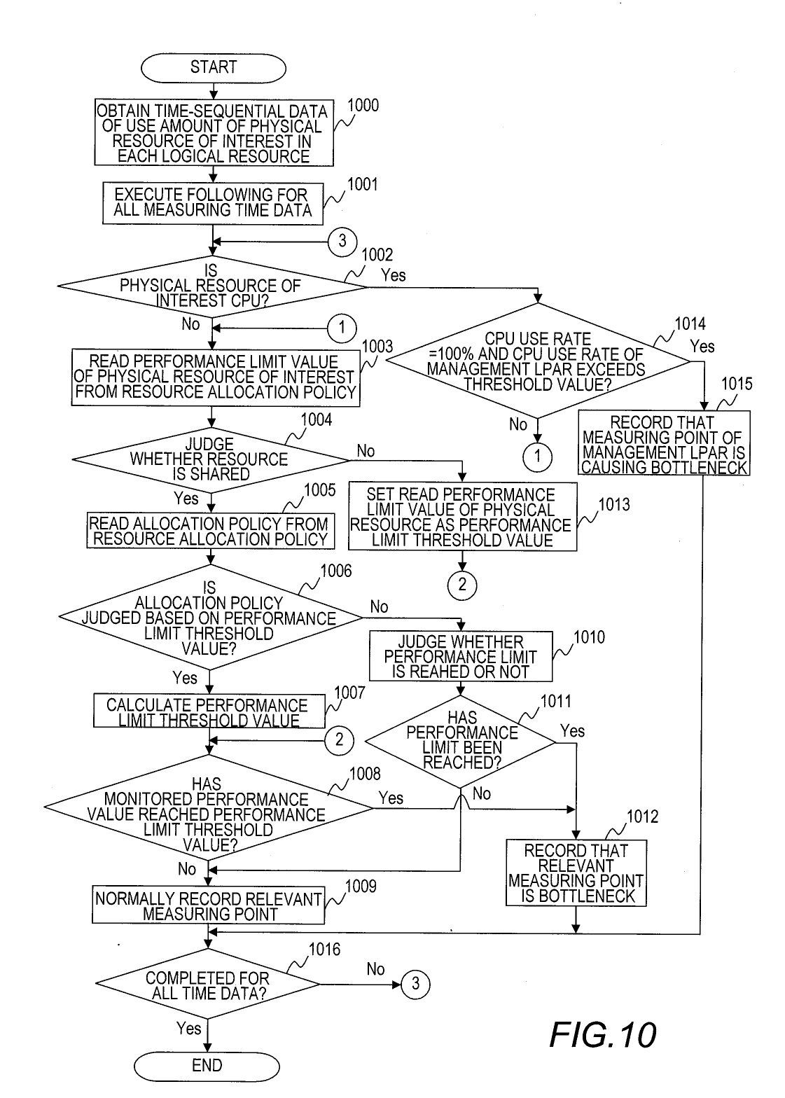

FIG. 10 is a flowchart illustrating bottleneck portion detection processing based on a resource allocation policy, which is executed by the management server 200 according to the first embodiment of this invention.

The control program 222 executes bottleneck detection based on a resource allocation policy by using the use situation of the physical resource of each time tabulated in the processing of FIG. 9.

In Step 1000, the control program 222 obtains time-sequential data of a use amount of a physical resource of interest in each logical resource. Bottleneck detection below is performed for all times of the time-sequential monitoring data obtained in Step 1000.

In Step 1001, the control program 222 executes processing of Steps 1002 to 1015 for all times.

In Step 1002, the control program 222 judges whether the physical resource of interest is a CPU.

If it is judged that the physical resource of interest is a CPU, the control program 222 executes processing to judge presence of a CPU bottleneck accompanying communication processing of the management LPAR.

Specifically, in Step 1014, the control program 222 judges whether a CPU use rate has reached 100%, and CPU processing of the management LPAR is operated (for example, whether a CPU use rate exceeds a threshold of about 1%).

If it is judged that the CPU use rate has reached 100%, and the CPU processing of the management LPAR is operated, in Step 1015, the control program 222 judges that a CPU bottleneck accompanying communication processing of the management LPAR has occurred, records that the relevant monitoring point (combination of time and logical resource) causes a bottleneck, and proceeds to Step 1016.

If it is judged in Step 1014 that the above-mentioned conditions are not satisfied, the control program 222 proceeds to Step 1003.

In a case where the physical resource of interest is a CPU, presence of a CPU processing bottleneck accompanying communication is preferentially judged. The reason is as follows. The CPU processing accompanying communication is expected to be operated by using an available CPU resource allocated to each LPAR, and a state where the management LPAR is operated accompanying communication to use the physical CPU up to 100% indicates a shortage of CPU resources secured for communication.

A specific reason for execution of the processing of the Steps 1002, 1014, and 1015 is as follows. As illustrated in FIG. 4, in a case where the LPARs 300 and 310 perform network communication, the network communication program 365 is executed in the management LPAR 360, and hence a load is generated on the CPU 111. In a case where a network communication amount is large, the above-mentioned load on the CPU 111 is considerable as compared with the processing of the LPARs 300 and 310, and hence the load must be taken into consideration in bottleneck detection.

Through the processing of Steps 1014 and 1015, the control program 222 can judge that the management LPAR for processing I/Os of other LPARs altogether has become a bottleneck due to I/O processing.

If it is judged in Step 1002 that the physical resource of interest is not a CPU, the control program 222 executes processing of Step 1003 and subsequent Steps.

In Step 1003, the control program 222 reads a performance limit value of the physical resource of interest from the resource allocation policy 233.

In Step 1004, the control program 222 judges whether the physical resource of interest is shared by a plurality of logical resources.

If it is judged that the physical resource of interest is shared by the plurality of logical resources, in Step 1005, the control program 222 reads a resource allocation policy of the physical resource of interest from the resource allocation policy 233.

In Step 1006, the control program 222 judges whether a threshold for a performance limit is used for the resource allocation policy.

Processing thereafter varies from one resource allocation policy to another. First, the resource allocation policy is described.

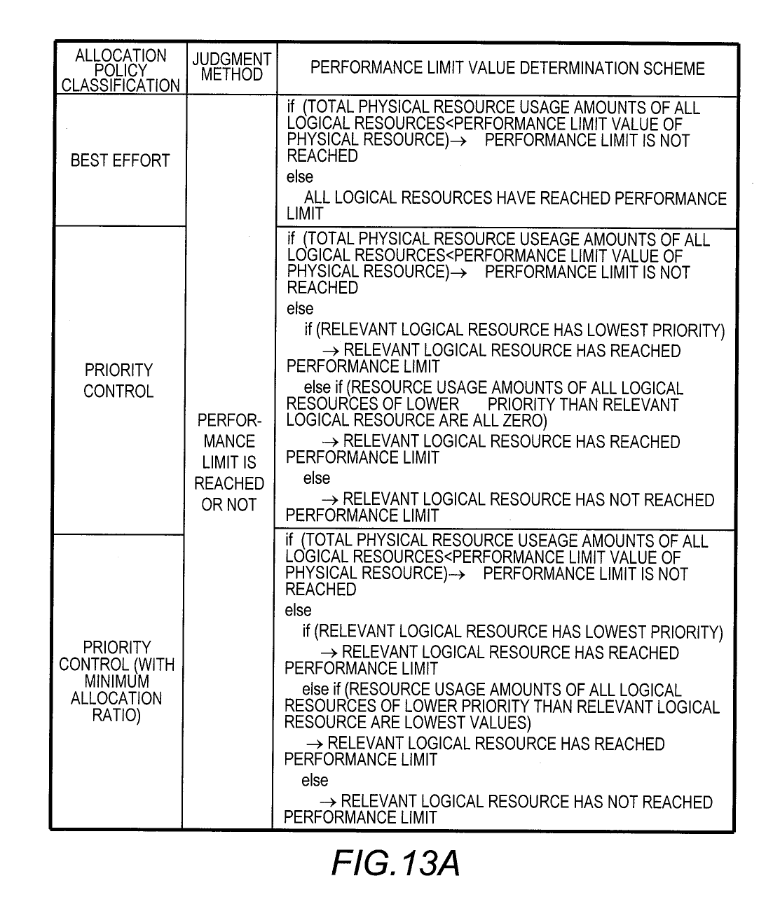

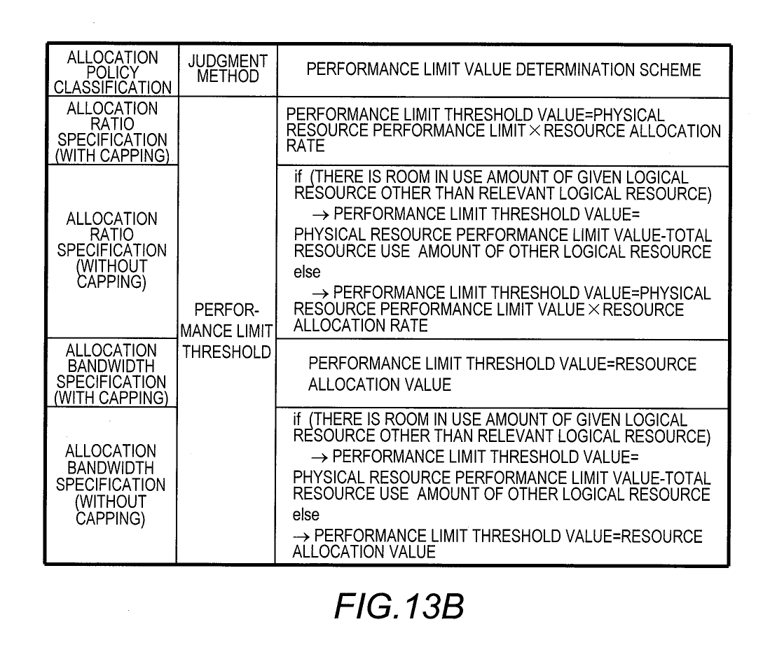

FIG. 13A and FIG. 13B are an explanatory diagram illustrating an example of a resource allocation policy according to the first embodiment of this invention.

FIG. 13A and FIG. 13B illustrate a judgment method and a performance limit determination scheme used for policies below. In this embodiment, resource allocation policies other than those of FIG. 13A and FIG. 13B can be used.

A resource allocation policy classification column indicates a method of a resource allocation policy. Specific examples are as follows.

Best Effort

Each logical resource uses a physical resource as much as possible.

Priority Control

Each logical resource uses a physical resource according to priority.

With a minimum allocation ratio specified, a predetermined amount of a physical resource is allocated to even a logical resource of low priority.

Allocation Ratio Specification

A physical resource of a specified ratio is allocated to each logical resource.

Allocation Value Specification

A physical resource allocation value to each logical resource is directly specified.

For allocation ratio specification and allocation value specification, presence of capping is also specified.

The judgment method column indicates whether judgment using “threshold for performance limit” is performed.

Specifically, in a case where an allocation bandwidth of a physical resource usable by a logical resource can be specified as in the case of allocation value specification or allocation ratio specification, judgment using “threshold for performance limit” is performed.

In a case where an allocation bandwidth of a physical resource usable by each logical source cannot be determined (due to correlation with use amounts of physical resources of the other logical resources) as in the case of the priority control, judgment without using any threshold for a performance limit is performed.

First, as an example where a threshold for a performance limit is used, a case where a logical resource is “SW 0-6” and an allocation policy is “allocation value specification with capping” is described. In this case, a threshold for a performance limit of each logical resource is a performance allocation value itself (for example, in the case of the sda 905 of the LPAR11 (410), a threshold for a performance limit is 2 Gbps).

In Step 1006, the control program 222 judges that a threshold for a performance limit is used for the resource allocation policy”. In Step 1007, the control program 222 calculates a threshold for performance limit. For example, in a case where a performance allocation ratio is 50% with capping, a threshold for performance limit is calculated as a value obtained by multiplying a physical resource performance limit value with 0.5.

In Step 1008, the control program 222 judges whether a monitored performance value (physical resource usage amount of a logical resource) has reached the threshold for a performance limit.

If it is judged that the monitored performance value (physical resource usage amount of the logical resource) has reached the threshold for the performance limit, in Step 1012, the control program 222 records that a relevant monitoring point (combination of time and logical resource) is a bottleneck, and proceeds to Step 1016.

If it is judged that the monitored performance value (physical resource usage amount of the logical resource) has not reached the threshold for the performance limit, in Step 1009, the control program 222 records that the relevant monitoring point is normal (not a bottleneck), and proceeds to Step 1016.

Through the above-mentioned processing, the control program 222 can detect that the logical resource has used up the physical resource allocation bandwidth (in the case of sda of the LPAR11, the SW 0-6 port has been used up to 2 Gbps).

Next, a judgment method for a case where the threshold for the performance limit is not used is described. In a case where the threshold for the performance limit is not used, the “performance limit value determination scheme” column of FIG. 13A indicates an algorithm for judging whether each logical resource has reached a performance limit (logical resource has used up the physical resource allocation bandwidth to become a bottleneck).

For example, to describe a case where “priority control” is performed (in priority control, a limit value of a physical resource usage amount of each logical resource cannot be determined beforehand, but changes depending on use amounts of the other logical resources), judgment is performed by the following method.

(1) When a total of relevant physical resource usage amounts of all the logical resources is smaller than a physical resource performance limit value (there is room in use amount of the physical resource), it is judged that no logical resource has reached the performance limit.

(2) When a physical resource is used to a limit,

(2a) if a logical resource has lowest priority, it is judged that the logical resource has reached the performance limit.

(2b) If a logical resource has no lowest priority, and resource usage amounts of logical resources having priority lower than that of this logical resource are all zero, it is judged that the logical resource has reached the performance limit.

(2c) If there is a value which is not zero among the resource usage amounts of the logical resources having priority lower than that of the logical resource, it is judged that the logical resource has not reached the performance limit.

Referring back to the flowchart of FIG. 10, in Step 1006, the control program 222 judges that the resource allocation policy does not use the threshold for the performance limit and, in Step 1010, judges whether a performance limit has been reached or not by using the algorithm of FIG. 13A.

In Step 1011, the control program 222 judges whether the performance limit has been reached based on a result of the processing for judging whether the performance limit has been reached or not.

If it is judged that the performance limit has been reached, in Step 1012, the control program 222 records that a relevant monitoring point is a bottleneck, and proceeds to Step 1016.

If it is judged that the performance limit has not been reached, in Step 1009, the control program 222 records that the relevant monitoring point is a normal, and proceeds to Step 1016.

Processing in resource allocation policy not described above referring to FIG. 13A and FIG. 13B is described.

Best Effort

In a case where a total of physical resource usage amounts of all the logical resources have reached the physical resource performance limit value, it is judged that all the logical resources have reached the performance limit.

Priority Control (With Minimum Allocation Ratio)

Although this priority control is similar to the above-mentioned priority control, if “a logical resource does not have lowest priority, and resource usage amounts of logical resources having priority lower than that of the logical resource are all minimum values” in (2b), it is judged that the logical resource has reached the performance limit. If “there is a value which is not a minimum value among resource usage amounts of the logical resources having priority lower than that of the logical resource” in (2c), it is judged that the logical resource has not reached the performance limit.

Allocation Value Specification with Capping

A threshold for a performance limit is calculated by the following algorithm.

(1) In a case where there is room in a physical resource usage amount of one of the logical resources other than the logical resource (physical resource usage amount is smaller than allocation bandwidth),

threshold for performance limit=physical resource performance limit value—total physical resource usage amount of other logical resources

(2) In a case where there is no room in resource usage amounts of any other logical resources,

threshold for performance limit=physical resource allocation value

Allocation Ratio Specification (With/Without Capping)

This method is similar to the method for the performance allocation value. However, in place of the performance allocation value, physical resource performance limit value×physical resource allocation ratio is used.

The above-mentioned performance limit value determination scheme is applied to judge presence of a bottleneck.

If it is judged in Step 1004 that the physical resource of interest is not shared by a plurality of logical resources, in Step 1013, the control program 222 sets a physical resource performance limit value as a “threshold for performance limit”, and proceeds to Step 1008. Thus, when the physical resource of interest is not shared, whether a hardware limit value is exceeded is judged.

In Step 1016, the control program 222 judges whether processing has been completed for all time data.

If it is judged that processing is yet to be completed for all time data, the control program 222 returns to Step 1002 to execute similar processing (Steps 1002 to 1016).

If it is judged that processing has been completed for all time data, the control program 222 terminates the processing.

Through the processing illustrated in FIG. 10, presence of a bottleneck (whether a logical resource has used up an allocation bandwidth determined by a policy) for a time-sequential monitoring point (value of each time) of a physical resource usage amount of each logical resource is recorded. As a result, the following is realized.

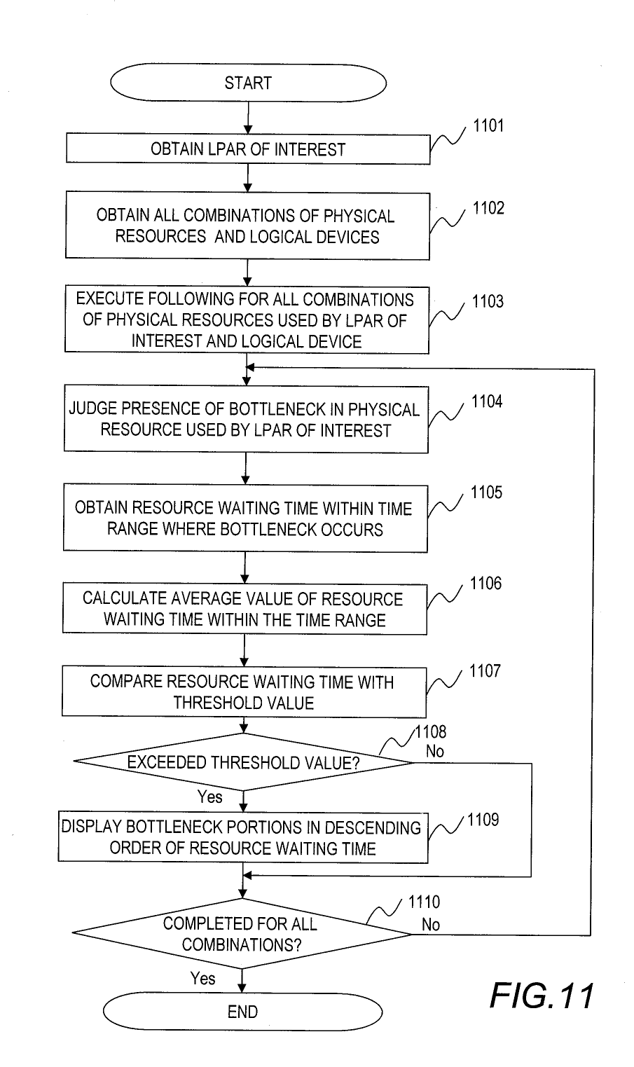

By using a result of the processing, through processing of FIG. 11 described below, priority judgment of bottleneck measures is executed by considering resource waiting time.

This processing is used when a portion where a resource usage amount has reached an allocation limit is reported on the physical resource bottleneck screen 2100 of FIG. 8. Specifically, for the physical resource of interest input to the input field 2110, a judgment result of the processing illustrated in FIG. 10 is obtained, and a monitoring point (time range) where reaching of an allocation limit by a resource usage amount and presence of a bottleneck are recorded is highlighted by a hatched line in FIG. 8. The alert output field 2130 displays that a resource usage amount has reached an allocation limit in the logical resource.

Next, a priority judgment flow of bottleneck measures considering resource waiting time is described.

FIG. 11 is a flowchart illustrating priority judgment processing of bottleneck measures considering resource waiting time executed by the management server 200 according to the first embodiment of this invention.

After completion of the processing of FIG. 10, the system administrator inputs an LPAR of interest to the input field 2010, and inputs a resource waiting time threshold 234 to the input field 2011 to start the priority judgment processing.

In Step 1101, the control program 222 obtains the LPAR of interest from the input field 2010.

In Step 1102, the control program 222 obtains combinations of physical resources used by the LPAR of interest and logical devices allocated to the LPAR from the system structure table 232.

For example, in a case where the LPAR11 (410) is specified as the LPAR of interest, “sda 905” is obtained as a logical resource, and “server01” of the CPU 23221, “HBA10” of the HBA 23222, “hport11” of the HBA port 23223, “SW 0-4” of the FC-SW port 23224, “SW 0” of the FC-SW 23225, “SW 0-6” of the FC-SW port 23226, “s-port1” of the storage port 23227, “CTRL1” of the controller 23228, and “RG03” of the RAID Group 23229 are obtained as physical resources.

In Step 1103, the control program 222 executes the following processing (Steps 1104 to 1109) for all the combinations of physical resources and logical devices.

In Step 1104, the control program 222 judges presence of a bottleneck (portion where an allocation bandwidth limit has been reached based on resource allocation policy) in a physical resource used by the LPAR of interest by referring to the result of the processing illustrated in FIG. 10.

In Step 1105, the control program 222 refers to the monitoring data 231 to obtain resource waiting time within a time range for which it is judged that where a bottleneck has occurred. In Step 1106, the control program 222 calculates an average value of the obtained resource waiting time.

For example, in a case of a physical resource is “SW 0-6” and a logical resource is “sda 905 of LPAR11 (410)”, an average value of monitored resource waiting time values for a period of 9:00 to 9:10 is calculated.

In Step 1107, the control program 222 compares the calculated resource waiting time average value with a threshold 234 for resource waiting time. In Step 1108, the control program 222 judges whether the calculated resource waiting time average value exceeds the threshold 234 for resource waiting time.

If it is judged that the calculated resource waiting time average value exceeds the threshold 234 for resource waiting time, in Step 1109, the control program 222 displays information (time range, logical device, and physical resource information) of relevant bottleneck portions on the output table 2020 in descending order of resource waiting time. Specifically, loop processing of Steps 1104 to 1110 is executed and, sequentially from a result of completed processing, information is displayed in descending order of resource waiting time on the output table 2020.

The control program 222 may execute processing of Steps 1103 to 1108 for all the obtained combinations of logical devices and physical resources, generate information to display bottleneck portions in descending order of resource waiting time based on a result of the processing, and display the output table 2020 based on the generated information.

If it is judged that the calculated resource waiting time average value does not exceed the threshold 234 for resource waiting time, the control program 222 proceeds to Step 1110.

In Step 1110, the control program 222 judges whether processing has been completed for all the combinations of logical devices and physical resources obtained in Step 1102.

If it is judged that processing is yet to be completed for all the combinations of a logical resource and physical resources obtained in Step 1102, the control program 222 returns to Step 1104 to execute processing of Steps 1104 to 1110.

If it is judged that processing has been completed for all the combinations of a logical resource and physical resources obtained in Step 1102, the control program 222 terminates the processing.

Through the above-mentioned processing, the bottleneck portion reporting screen 2000 of FIG. 7 is displayed.

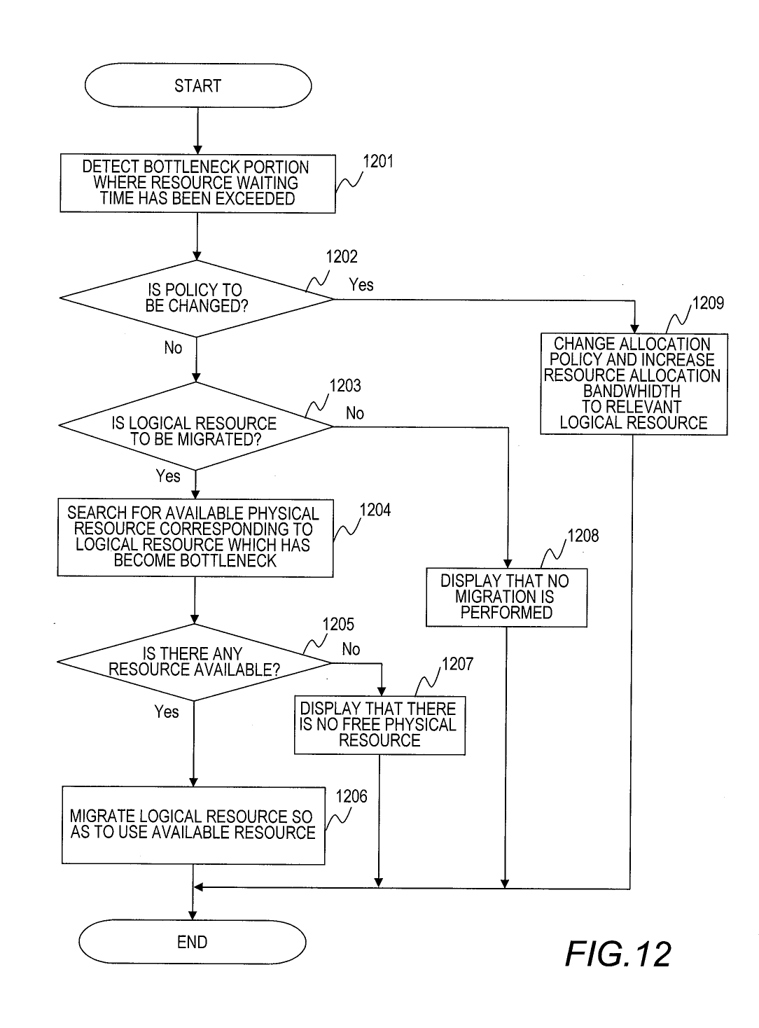

Next, referring to FIG. 12, an operation of the control program 222 in the management server 200 after bottleneck detection is described.

FIG. 12 is a flowchart illustrating bottleneck solution processing executed by the management server 200 according to the first embodiment of this invention.

In this processing, in order to solve bottlenecks, interactive processing is performed with the system administrator via the display device 240.

In Step 1201, the processing is started after completion of the processing illustrated in FIG. 11.

In Step 1202, the control program 222 judges whether to change a resource allocation policy. Specifically, the management server 200 executes the display program 223, and displays a message prompting an instruction about a change of the resource allocation policy on the display device 240. The system administrator instructs whether to change the resource allocation policy based on the message.

If it is judged that the resource allocation policy is to be changed, in other words, when the management server 200 receives an instruction to change the resource allocation policy from the system administrator, in Step 1209, the control program 222 changes the resource allocation policy. Specifically, the management server 200 transmits a changing instruction of the resource allocation policy including an instruction to increase a resource allocation bandwidth of the logical resource judged to have a bottleneck occurred to the policy management server 190.

Contents of a policy itself are determined by the system administrator considering work priority of each LPAR. In the example of FIG. 8, there is room in a use rate of the physical port SW 0-6 of the switch, and hence measures such as setting of “without capping” with respect to the logical resource of the allocation policy can be taken.

If it is judged that the resource allocation policy is not to be changed, in other words, in a case where the management server 200 receives an instruction not to change the resource allocation policy from the system administrator, in Step 1203, the control program 222 judges whether to migrate the logical resource. Specifically, the management server 200 executes the display program 223, and displays, for example, a message prompting an instruction about whether to migrate the logical resource on the display device 240.

If it is judged that the logical resource is not to be migrated, in other words, in a case where the management server 200 receives an instruction not to migrate the logical resource from the system administrator, in Step 1208, the control program 222 displays a message of non-migration on the display device 240.

If it is judged that the logical resource is to be migrated, in other words, in a case where the management server 200 receives an instruction to migrate the logical resource from the system administrator, in Step 1204, the control program 222 searches for an available resource permitted to be allocated to a logical resource which has become a bottleneck. In Step 1205, the control program 222 judges whether there is any available resource permitted to be allocated to the logical resource which has become a bottleneck.

If it is judged that there is an available resource permitted to be allocated to the logical resource which has become a bottleneck, in Step 1206, the control program 222 migrates the logical resource to the available resource.

If it is judged that there is no available resource permitted to be allocated to the logical resource which has become a bottleneck, in Step 1207, the control program 222 displays a message of no available resource on the display device 240.

To describe by taking the example of FIG. 2, when the port SW 0-6 of the FC-SW is a bottleneck, if there is sufficient room in use rate of the port SW 0-5 or the controller CTRL0 of the storage, the control program 222 can take measures such as changing of coupling between a responsible controller on the storage side of sda 905 accessed by the LPAR11 (410) and the FC-SW or changing of an access path so as to access via the SW 0-5 and the CTRL0.

Through the above-mentioned processing, the management server 200 can execute a series of flows including monitoring of a resource use rate, bottleneck detection, and bottleneck measures.

### Modified Example 1

In the first embodiment, on the physical resource bottleneck screen 2100 of FIG. 8, the portion where the bottleneck has occurred is highlighted. However, in addition to the method of highlighting the bottleneck portion only after the limit is reached, a method for displaying use amounts of physical resources used for logical resources by changing colors according to a use rate before the limit is reached may be employed.

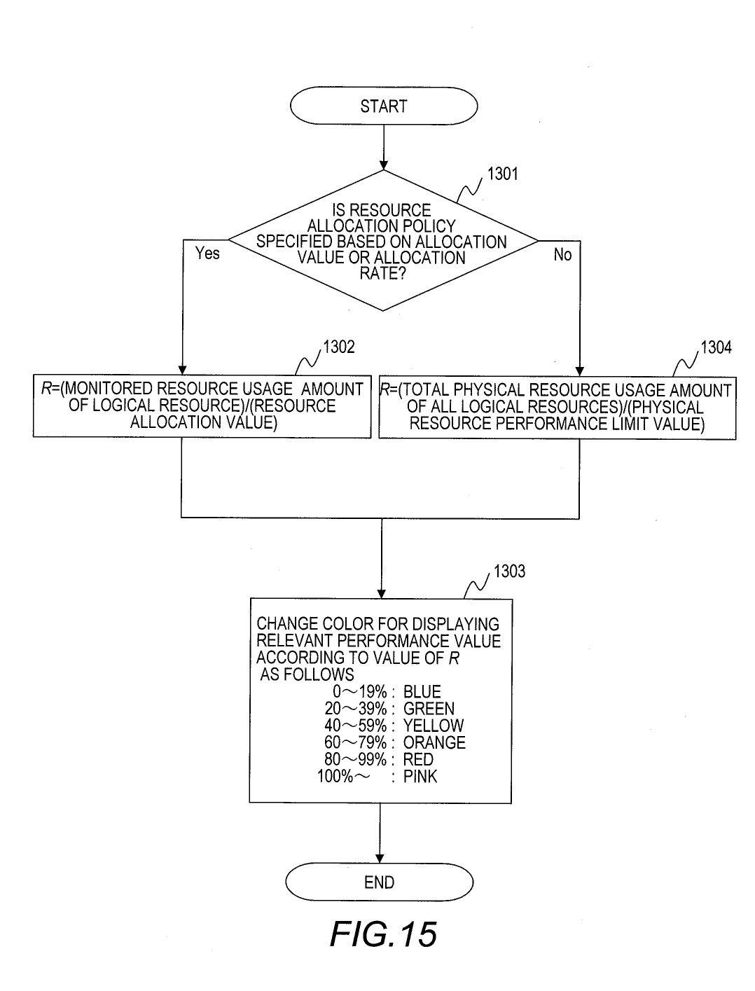

FIG. 15 is a flowchart illustrating a modified example of a display method of the physical resource bottleneck screen 2100 according to the first embodiment of this invention.

In Step 1301, the control program 222 judges whether in the resource allocation policy, resource allocation to a logical resource is specified by an allocation value or an allocation ratio.

If it is judged that resource allocation to the logical resource is specified by an allocation value or an allocation ratio, in Step 1302, the control program 222 calculates a variable R as follows. That is, in a case where resource allocation to the logical resource is specified by an allocation value, the variable R is calculated by the following formula (1).

R=resource usage amount monitored value of logical resource/resource allocation value (1)

Further, in a case where resource allocation to the logical resource is specified by an allocation ratio, the variable R is calculated by the following formula (2).

R=performance limit value of physical resource/allocation ratio (2)

If it is judged that resource allocation to the logical resource is not specified by an allocation value or an allocation ratio, in Step 1304, the control program 222 calculates the variable R by the following formula (3).

R=total physical resource usage amount of all logical resources/physical resource performance limit value (3)

The variable R is an index indicating an amount of use with respect to physical resource amount allocated to the logical resource. If priority control where no allocation ratio or allocation bandwidth is specified for each logical resource is performed (Step 1304), the variable R is calculated not by each logical resource but by all logical resources together.

In Step 1303, the control program 222 changes colors based on the calculated value of the variable R, and draws a graph illustrating use amounts of physical resources used for relevant logical resources.

It should be noted that with capping, a value of the variable R is 100% or more. In this case, there is no direct relationship between a case where the value of the variable R exceeds 100% and a case where a relevant logical resource is a bottleneck (physical resource is used to a limit) (in a case where there is an available use amount of other logical resource, even if the use amount of the logical resource exceeds 100%, no bottleneck is detected). Thus, highlighting of the bottleneck range as illustrated in FIG. 8 and coloring of this modified example must be performed independently.

This processing is started after a physical resource of interest is input to the input field 2110 of the physical resource bottleneck screen 2100.

According to the modified example 1, room in a physical resource usage amount of each logical resource up to a limit can be visually recognized, and system performance management can be facilitated.

### Modified Example 2

In the first embodiment, as an index indicating influence of I/O access performance on software, an absolute value of resource waiting time is used. However, while being simple, the index varies depending on attributes of data to be accessed, and hence in the LPAR which accesses data of different attributes, in a case where performance is compared among a plurality of logical devices, accurate comparison may not be performed. For example, in a case where an OS is different, a monitoring method of resource waiting time differs for each OS. Thus, the index is not appropriate for comparison.

In order to solve the problem, a method may be employed, which uses, in place of the absolute value of resource waiting time, a ratio between resource waiting time during normal time and resource waiting time when I/O throughput reaches a limit as an index of influence on software.

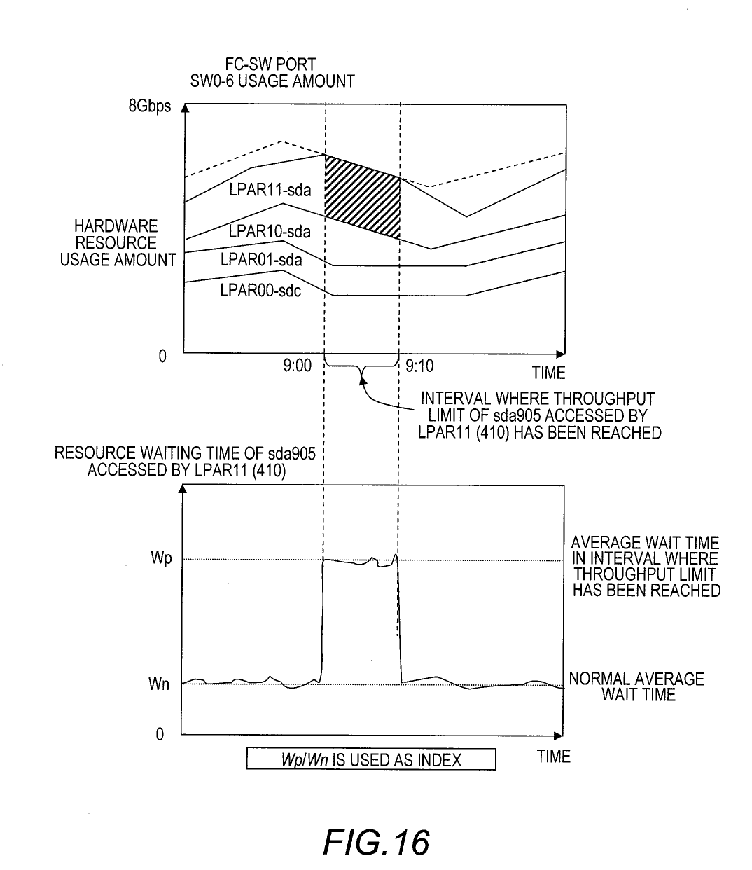

FIG. 16 illustrates a calculation method of a resource waiting time ratio in a modified example of the first embodiment of this invention.

An upper table of FIG. 16 illustrates a time-sequential change of a hardware resource usage amount (graph identical to the output graph 2120 of FIG. 8), and a lower table of FIG. 16 illustrates a time-sequential change of resource waiting time of sda 905 accessed by the LPAR11 (410).

In both graphs, horizontal axes indicate the same time. As illustrated in FIG. 16, within a time range where throughput of a logical resource has reached a limit, a value of resource waiting time is large.

Hereinafter, Wp indicates an average value of resource waiting time within the time range where throughput of the logical resource has reached the limit, and Wn indicates an average value of resource waiting time in other sections. In the first embodiment, Wp is used as an index indicating influence of I/O access performance on software. In this modified example, however, Wp/Wn is used as an index indicating influence of I/O access performance on software.

Specifically, in place of Steps 1105 and 1106 of FIG. 11, the control program 222 executes the following steps.

(1) Step of calculating Wp and Wn from information of a time range where bottleneck occurs and time-sequential change data of resource waiting time of the logical device.

(2) Step of calculating Wp/Wn.

Threshold judgment and displaying thereafter are executed by the same algorithm as that of the first embodiment.

According to the modified example 2, even influences of I/O accesses of different characteristics on software can be compared by using the same index.

This invention may be implemented by using not resource waiting time but an I/O queue length, service time, and a load average (queue length) of the CPU as a performance index. In this invention, the average value of the monitored values is used. However, a maximum value may be used.

As described above, according to this invention, in an environment where a plurality of logical resources shares a physical resource, whether a use amount of a logical resource has reached a bottleneck (reached a predetermined allocation value limit) can be judged by considering a resource allocation policy. Further, influence of a portion judged to be a bottleneck on software can be judged, and a portion having a large adverse effect on the software can be navigated.

As a result, bottleneck detection considering the resource allocation policy and influence on the software which the conventional performance monitoring system has been unable to realize can be realized, and the system administrator can quickly take performance measures.

While the present invention has been described in detail and pictorially in the accompanying drawings, the present invention is not limited to such detail but covers various obvious modifications and equivalent arrangements, which fall within the purview of the appended claims.

What is claimed is:

1. A performance monitoring system, comprising:
a server;
a storage system coupled to the server; and
a management server for managing the server and the storage system, wherein:
the server comprises a first processor, a first memory coupled to the first processor, and a first network interface coupled to the first processor;
the storage system comprises, a controller, a storage device, and a disk interface for interconnecting the controller and the storage device;
the controller comprises a second processor, and a second memory coupled to the second processor;
the management server comprises a third processor, a third memory coupled to the third processor, and a storage device coupled to the third processor;
the server comprises a plurality of virtual machines executed therein, the plurality of virtual machines being generated by logically dividing the server;
the storage system provides logical storage units, generated by logically dividing the storage device, to the plurality of virtual machines;
logical resources, which are logically divided physical resources in a path from one of the plurality of virtual machine to the logical storage units, is allocated to each of the plurality of virtual machines;
the server gathers time-sequential data regarding use amounts of the physical resources used for the logical resources, which are monitored by each of the plurality of virtual machines, for each of the logical resources; and
the management server is configured to:
manage information regarding a resource allocation policy set for the logical resources;
obtain the gathered time-sequential data from the server;
judge whether at least one bottleneck has occurred in the logical resource of a specified one of the plurality of virtual machines at each time of the obtained time-sequential data, by referring to use amounts of the physical resources used for the logical resources of the specified one of the plurality of virtual machines and the resource allocation policy;
obtain a performance value indicating influence of performance of the logical resource where at least one bottleneck has occurred on performance of the specified one of the plurality of virtual machines;
judge, based on the obtained performance value, whether at least one bottleneck causing large influence on the specified one of the plurality of virtual machines has occurred; and
notify that at least one large bottleneck has occurred in the specified one of the plurality of virtual machines in a case where it is judged that at least one bottleneck causing large influence on the specified one of the plurality of virtual machines has occurred.

2. The performance monitoring system according to claim 1, wherein:
the performance value to be used comprises, a parameter indicating an overhead of a resource queue in an operating system executed in each of the plurality of virtual machines; and
the management server is further configured to:
judge whether the performance value is larger than a preset threshold, in a case of judging whether at least one bottleneck causing large influence on the specified one of the plurality of virtual machines has occurred; and
judge that at least one of bottleneck causing large influence on the specified one of the plurality of virtual machines has occurred, in a case where the performance value is larger than the preset threshold.

3. The performance monitoring system according to claim 1, wherein:
the performance value to be used comprises a ratio of use amounts of the physical resources used for the logical resources when at least one bottleneck has occurred to use amounts of the physical resources used for the logical resources when no bottleneck has occurred; and
the management server is further configured to:
judge whether the performance value is larger than a preset threshold, in a case of judging whether at least one bottleneck causing large influence on the specified one of the plurality of virtual machines has occurred; and
judge that at least one bottleneck causing large influence on the specified one of the plurality of virtual machines has occurred, in a case where the performance value is larger than the preset threshold.

4. The performance monitoring system according to claim 1, further comprising a display unit for displaying a judging result of the management server,
wherein the management server is further configured to:
generate display information for displaying bottlenecks, causing large influence on the specified one of the plurality of virtual machines are judged to have occurred, in descending order of influence on the specified one of the plurality of virtual machines; and
display the generated display information on the display unit.

5. The performance monitoring system according to claim 1, further comprising a display unit for displaying a judging result of the management server,
wherein the management server displays selection of one of changing of the resource allocation policy and migrating the logical resource to the physical resource where no bottleneck has occurred on the display unit, in a case where an occurrence of at least one bottleneck causing large influence on the specified one of the plurality of virtual machines is detected.

6. The performance monitoring system according to claim 1, further comprising a display unit for displaying a judging result of the management server,
wherein the management server is further configured to:
display use amounts of the physical resources used for the logical resources on the display unit; and
highlight a portion where the bottleneck has occurred, in a case where an occurrence of at least one bottleneck in the logical resources of the specified one of the plurality of virtual machines is detected.

7. The performance monitoring system according to claim 6, wherein the management server is further configured to:
calculate a ratio of use amounts of the physical resources used for the logical resources to amounts of allocation of the physical resources to the logical resources; and
change a display method for the portion where the bottleneck has occurred, according to the ratio.

8. A bottleneck detection method used in a performance monitoring system comprising:
a server;
a storage system coupled to the server; and
a management server for managing the server and the storage system,
the server comprising: a first processor, a first memory coupled to the first processor, and a first network interface coupled to the first processor,
the storage system comprising: a controller, a storage device, and a disk interface for interconnecting the controller and the storage device,
the controller comprising: a second processor, and a second memory coupled to the second processor,
the management server comprising: a third processor, a third memory coupled to the third processor, and a storage device coupled to the third processor,
the server comprising a plurality of virtual machines executed therein, the plurality of virtual machines being generated by logically dividing the server,
the storage system providing logical storage units generated by logically dividing the storage device to the plurality of virtual machines,
logical resources, which are logically divided physical resources in a path from one of the plurality of virtual machine to the logical storage units, is allocated to each of the plurality of virtual machines,
the server gathers time-sequential data regarding use amounts of the physical resources used for the logical resources, which are monitored by each of the plurality of virtual machines, for each of the logical resources,
the management server manages information regarding a resource allocation policy set for the logical resources,
the bottleneck detection method including:
obtaining, by the management server, the gathered time-sequential data from the server;
judging, by the management server, whether at least one bottleneck has occurred in the logical resources of a specified one of the plurality of virtual machines at each time of the obtained time-sequential data, by referring to use amounts of the physical resources used for the logical resources of the specified one of the plurality of virtual machines and the resource allocation policy;
obtaining, by the management server, a performance value indicating influence of performance of the logical resource where at least one bottleneck has occurred on performance of the specified one of the plurality of virtual machines;
judging, by the management server, whether at least one bottleneck causing large influence on the specified one of the plurality of virtual machines has occurred based on the obtained performance value; and
notifying, by the management server, that at least one large bottleneck has occurred in the specified one of the plurality of virtual machines in a case where it is judged that at least one bottleneck causing large influence on the specified one of the plurality of virtual machines has occurred.

9. The bottleneck detection method according to claim 8, wherein:
the performance value to be used comprises, a parameter indicating an overhead of a resource queue in an operating system executed in each of the plurality of virtual machines; and
the bottleneck detection method further includes:
judging, by the management server, whether the performance value is larger than a preset threshold in a case of judging whether at least one bottleneck causing large influence on the specified one of the plurality of virtual machines has occurred; and
judging, by the management server, that at least one bottleneck causing large influence on the specified one of the plurality of virtual machines has occurred, in a case where the performance value is larger than the preset threshold.

10. The bottleneck detection method according to claim 8, wherein:
the performance value to be used comprises a ratio of use amounts of the physical resources used for the logical resources when at least one bottleneck has occurred to use amounts of the physical resources used for the logical resources when no bottleneck has occurred; and
the bottleneck detection method further includes:
judging, by the management server, whether the performance value is larger than a preset threshold in a case of judging whether at least one bottleneck causing large influence on the specified one of the plurality of virtual machines has occurred; and
judging, by the management server, that at least one bottleneck causing large influence on the specified one of the plurality of virtual machines has occurred, in a case where the performance value is larger than the preset threshold.

11. The bottleneck detection method according to claim 8, wherein:
the performance monitoring system further comprises a display unit for displaying a judging result of the management server; and
the bottleneck detection method further includes:
generating, by the management server, display information for displaying bottlenecks causing large influence on the specified one of the plurality of virtual machines are judged to have occurred in descending order of influence on the specified one of the plurality of virtual machines; and
displaying, by the management server, the generated display information on the display unit.

12. The bottleneck detection method according to claim 8, wherein:
the performance monitoring system further comprises a display unit for displaying a judging result of the management server; and
the bottleneck detection method further includes displaying, by the management server, selection of one of changing of the resource allocation policy and migrating the logical resource to the physical resource where no bottleneck has occurred on the display unit, in a case where an occurrence of at least one bottleneck causing large influence on the plurality of virtual machines is detected.

13. The bottleneck detection method according to claim 8, wherein:
the performance monitoring system further comprises a display unit for displaying a judging result of the management server; and
the bottleneck detection method further comprises:
displaying, by the management server, use amounts of the physical resources used for the logical resources on the display unit; and
highlighting, by the management server, a portion where the bottleneck has occurred, in a case where an occurrence of the bottleneck in the logical resources of the specified one of the plurality of virtual machines is detected.

14. The bottleneck detection method according to claim 13, further comprising:
calculating, by the management server, a ratio of use amount of the physical resources used for the logical resources to amounts of allocation of the physical resources to the logical resources; and
changing, by the management server, according to the ratio, a display method for the portion where the bottleneck has occurred.

15. A management server in a performance monitoring system comprising:
a server; and a storage system coupled to the server, the management server managing the server and the storage system,
the server comprising: a first processor; a first memory coupled to the first processor; and a first network interface coupled to the first processor,
the storage system comprising: a controller; a storage device; and a disk interface for interconnecting the controller and the storage device,
the controller comprising: a second processor; and a second memory coupled to the second processor,
the server comprising a plurality of virtual machines executed therein, the plurality of virtual machines being generated by logically dividing the server,
the storage system providing logical storage units generated by logically dividing the storage device to the plurality of virtual machines,
the management server comprises: a third processor; a third memory coupled to the third processor; and a storage device coupled to the third processor,
the management server being configured to:
manage information regarding a resource allocation policy set for logical resources, which are logically divided are physical resources in a path from the plurality of virtual machines to the logical storage units, allocated to each of the plurality of virtual machines and;
obtain time-sequential data regarding use amounts of the physical resources used for the logical resources, which are monitored by the server for each of the logical resources;
judge whether at least one bottleneck has occurred in the logical resources of the specified one of a plurality of virtual machines at each time of the obtained time-sequential data, by referring to use amounts of the physical resources used for the logical resources of the specified one of the plurality of virtual machines and the resource allocation policy;
obtain a performance value indicating influence of performance of the logical resources where at least one bottleneck has occurred on performance of the specified one of the plurality of virtual machines;
judge whether at least one bottleneck causing large influence on the specified one of the plurality of virtual machines has occurred, based on the obtained performance value; and
notify that at least one large bottleneck has occurred in the specified one of the plurality of virtual machines, in a case where it is judged that at least one bottleneck causing large influence on the specified one of the plurality of virtual machines has occurred.
